(19) United States
(12) Patent Application Publication
(10) Pub. No.: US 2024/0078349 A1
(43) Pub. Date: Mar. 7, 2024

(54) SYSTEMS AND METHODS FOR MANAGING A DISTRIBUTED COMPUTER-AIDED DESIGN (CAD) SYSTEM

(71) Applicant: Ford Global Technologies, LLC, Dearborn, MI (US)

(72) Inventor: Steven Schuchard, Farmington Hills, MI (US)

(73) Assignee: Ford Global Technologies, LLC, Dearborn, MI (US)

(21) Appl. No.: 17/939,505

(22) Filed: Sep. 7, 2022

(51) Int. Cl. G06F 30/00

(52) U.S. Cl. CPC G06F 30/00; G06F 2111/02

(57) ABSTRACT

A distributed CAD system includes a server computing device comprising a reference CAD object database and a CAD file database. The reference CAD object database comprises a plurality of reference CAD objects, the CAD file database comprises one or more master CAD files, and each of the one or more master CAD files comprises master object information and master identification information. The distributed CAD system includes a plurality of client computing devices. Each of the plurality of client computing devices comprises a client database, and each client database comprises one or more local CAD files and local object information associated with each of the one or more local CAD files. The server computing device is configured to determine whether an input received by a given client computing device from among the plurality of client computing devices satisfies one of a file creation condition and a file modification condition.

### FIELD

The present disclosure relates to systems and methods for managing a distributed computer-aided design (CAD) system.

### BACKGROUND

The statements in this section merely provide background information related to the present disclosure and may not constitute prior art.

In a manufacturing environment, CAD modeling software aids in the creation, modification, analysis, and/or enhancement of the design of, for example, finished workpieces (e.g., vehicles or components thereof), manufacturing processes, and/or equipment utilized to fabricate the finished workpieces. Different manufacturing entities may utilize various versions and/or types of the CAD modeling software, and a given manufacturing entity may have CAD modeling software that is not able to interpret, view, and/or modify CAD files generated by another manufacturing entity. More specifically, various entities may not collaborate with other entities to view and/or modify a CAD file due to, for example, native CAD modeling software types and/or versions that are incompatible amongst each other. This issue with CAD modeling software, among other issues, is addressed by the present disclosure.

### SUMMARY

This section provides a general summary of the disclosure and is not a comprehensive disclosure of its full scope or all of its features.

The present disclosure provides a distributed CAD system that includes a server computing device comprising a reference CAD object database and a CAD file database. The reference CAD object database comprises a plurality of reference CAD objects, the CAD file database comprises one or more master CAD files, and each of the one or more master CAD files comprises master object information and master identification information. The distributed CAD system includes a plurality of client computing devices communicably coupled to the server computing device. Each of the plurality of client computing devices comprises a client database, and each client database comprises one or more local CAD files and local object information associated with each of the one or more local CAD files. The server computing device is configured to determine whether an input received by a given client computing device from among the plurality of client computing devices satisfies one of a file creation condition and a file modification condition. In response to the input satisfying the file creation condition, the server computing device is configured to generate an additional master CAD file from among the one or more master CAD files based on the input and the plurality of reference CAD objects. In response to the input satisfying the file modification condition, the server computing device is configured to select a target master CAD file from among the one or more master CAD files based on the input, select one or more target local CAD files from among the one or more local CAD files stored on each client database of one or more additional client computing devices from among the plurality of client computing devices, and selectively update the target master CAD file. In response to the input satisfying the file modification condition, the one or more additional client computing devices are configured to selectively update the one or more target local CAD files.

In one form, each reference CAD object from among the plurality of reference CAD objects is associated with one or more CAD graphic formats. In one form, the one or more CAD graphic formats includes a two-dimensional (2D) graphic type, a three-dimensional (3D) graphic type, an augmented reality graphic type, a virtual reality graphic type, or a combination thereof. In one form, the input satisfies the file creation condition in response to the input corresponding to the given client computing device generating an additional local CAD file from among the one or more local CAD files.

In one form, the input satisfies the file modification condition in response to the input corresponding to the given client computing device opening a given local CAD file from among the one or more local CAD files. In one form, the server computing device is further configured to select the target master CAD file based on local identification information of the given local CAD file, where the master identification information of the target master CAD file matches the local identification information of the given local CAD file; determine whether the master object information of the target master CAD file matches local object information of the given local CAD file; and update the target master CAD file in response to the local object information of the given local CAD file not matching the master object information. In one form, the server computing device is further configured to select the one or more target local CAD files based on the master identification information and local identification information of the one or more target local CAD files, where the master identification information of the target master CAD file matches the local identification information of the one or more target local CAD files. In one form, the server computing device is further configured to select the one or more target local CAD files based on the master identification information and local identification information of the one or more target local CAD files, where the master identification information of the target master CAD file matches the local identification information of the one or more target local CAD files. In one form, the server computing device is further configured to determine whether the master object information matches local object information of the one or more target local CAD files. In one form, the one or more additional client computing devices are further configured to update the one or more target local CAD files in response to the local object information of the one or more target local CAD files not matching the master object information.

In one form, the input satisfies the file modification condition in response to the input corresponding to the given client computing device modifying local object information of a given local CAD file from among the one or more local CAD files. In one form, the server computing device is further configured to select the target master CAD file based on local identification information of the given local CAD file, where the master identification information of the target master CAD file matches the local identification information of the given local CAD file; and update the master object information of the target master CAD file based on the local object information of the given local CAD file. In one form, the server computing device is further configured to select the one or more target local CAD files based on the master identification information and local identification information of the one or more target local CAD files, where the master identification information of the target master CAD file matches the local identification information of the one or more target local CAD files. In one form, the one or more additional client computing devices are further configured to update local object information of the one or more target local CAD files based on the master object information of the target master CAD file.

The present disclosure provides a method for managing a distributed CAD system comprising a server computing device communicably coupled to a plurality of client computing devices. The method includes determining, by the server computing device, whether an input received by a given client computing device from among the plurality of client computing devices satisfies one of a file creation condition and a file modification condition, where: the server computing device comprises a reference CAD object database and a CAD file database; the reference CAD object database comprises a plurality of reference CAD objects; the CAD file database comprises one or more master CAD files; each of the one or more master CAD files comprises master object information and master identification information; each of the plurality of client computing devices comprises a client database; and each client database comprises one or more local CAD files and local object information associated with each of the one or more local CAD files. The method includes generating, by the server computing device and in response to the input satisfying the file creation condition, an additional master CAD file from among the one or more master CAD files based on the input and the plurality of reference CAD objects. The method includes, in response to the input satisfying the file modification condition: selecting, by the server computing device, a target master CAD file from among the one or more master CAD files based on the input; selecting, by the server computing device, one or more target local CAD files from among the one or more local CAD files stored on each client database of one or more additional client computing devices from among the plurality of client computing devices; selectively updating, by the server computing device, the target master CAD file; and selectively updating, by the one or more additional client computing devices, the one or more target local CAD files.

In one form, selecting the target master CAD file is further based on local identification information of the given local CAD file, where the master identification information of the target master CAD file matches the local identification information of the given local CAD file, and where the method further comprises: determining, by the server computing device, whether the master object information of the target master CAD file matches local object information of the given local CAD file; and updating, by the server computing device, the target master CAD file in response to the local object information of the given local CAD file not matching the master object information.

In one form, selecting the one or more target local CAD files is further based on the master identification information and local identification information of the one or more target local CAD files, where the master identification information of the target master CAD file matches the local identification information of the one or more target local CAD files, and where the method further comprises: determining, by the server computing device, whether the master object information matches local object information of the one or more target local CAD files; and updating, by the one or more additional client computing devices, the one or more target local CAD files in response to the local object information of the one or more target local CAD files not matching the master object information.

In one form, selecting the target master CAD file is further based on local identification information of the given local CAD file, where the master identification information of the target master CAD file matches the local identification information of the given local CAD file, and where the method further comprises updating, by the server computing device, the master object information of the target master CAD file based on the local object information of the given local CAD file.

In one form, selecting the one or more target local CAD files is further based on the master identification information and local identification information of the one or more target local CAD files, where the master identification information of the target master CAD file matches the local identification information of the one or more target local CAD files, and where the method further comprises updating, by the one or more additional client computing devices, local object information of the one or more target local CAD files based on the master object information of the target master CAD file.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a functional block diagram of a distributed CAD system in accordance with the teachings of the present disclosure;

FIG. 2 is a functional block diagram of a distributed CAD system in accordance with the teachings of the present disclosure; and

FIG. 3 is a flowchart of an example control routine in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure provides a distributed CAD system that enables various entities (e.g., vendors, manufacturing facilities, administrators, among other entities) to collaboratively view, create, modify, and delete CAD files in real time via an application programming interface that connects a server computing device and a plurality of client computing devices. More specifically, the distributed CAD system includes one or more modules that enable an entity to view, create, modify, and delete CAD files regardless of the CAD modeling software types and/or versions being executed by the entity. As such, the distributed CAD system enables an entity to perform various actions within a distributed CAD system that is agnostic to the CAD modeling software type and/or version.

Additionally, the distributed CAD system includes a server computing device that is configured to selectively update local CAD files stored on the various client computing devices when a file creation condition or a file modification condition is satisfied. As such, the distributed CAD system described herein is an agnostic CAD system that enables multiple entities to collaboratively view, modify, and store updated CAD files in real time.

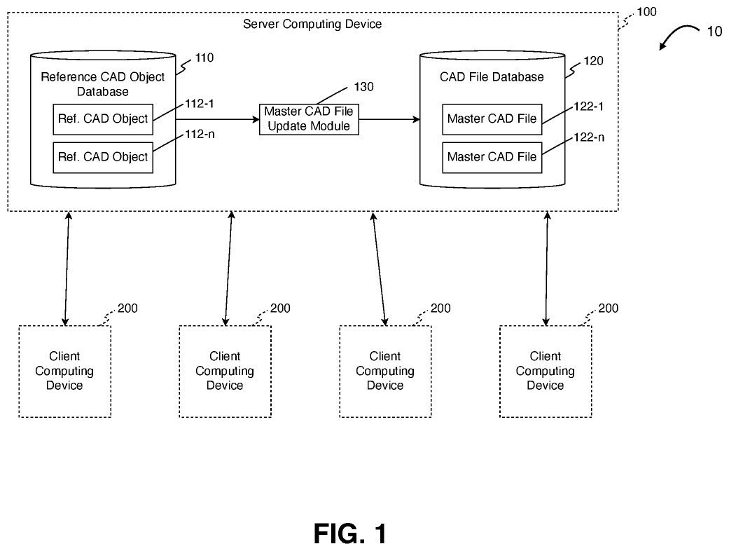

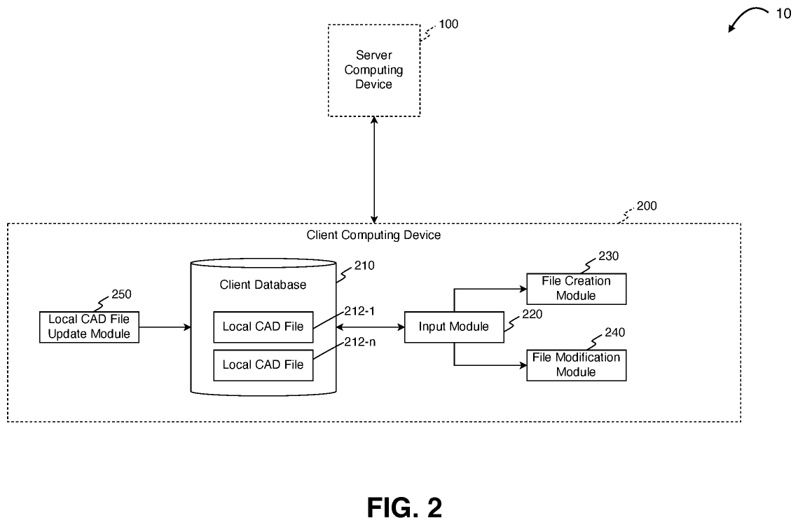

Referring to FIGS. 1-2, a distributed CAD system 10 that is provided in, for example, one or more manufacturing environments is shown. In one form, the distributed CAD system 10 includes a server computing device 100 and a plurality of client computing devices 200-1, 200-2, 200-3, . . . 200-n (collectively referred to hereinafter as “client computing devices 200”). In one form, the server computing device 100 and the client computing devices 200 are communicably coupled using a wired and/or wireless communication protocol (e.g., a Bluetooth®-type protocol, a cellular protocol, a wireless fidelity (Wi-Fi)-type protocol, a near-field communication (NFC) protocol, an ultra-wideband (UWB) protocol, among others). In one form, each of the client computing devices 200 may be associated with a given manufacturing entity among one or more manufacturing entities.

In one form, the server computing device 100 and the client computing devices 200 are communicably coupled to each other via an application programming interface (API) that is uniquely defined for the server computing device 100 and the client computing devices 200. As an example, the API may include one or more server tags that communicably couple the server computing device 100 and the client computing devices 200 to a remote server (e.g., a JAVA® JavaServer, Python® client server, among other servers) via a transmission control protocol (TCP) socket and thereby enables communication between the server computing device 100 and the client computing devices 200.

In one form, the server computing device 100 includes a reference CAD object database 110, a CAD file database 120, and a master CAD file update module 130. In one form, the reference CAD object database 110 comprises a plurality of reference CAD objects 112-1, . . . 112-n (collectively referred to hereinafter as “reference CAD objects 112”). The reference CAD objects are CAD objects that facilitate component or workstation design in a manufacturing environment (e.g., a vehicle manufacturing environment) when, for example, a user of the client computing devices 200 is executing CAD modeling software. As an example, the reference CAD objects 112 may correspond to tools, fixtures, workpieces (e.g., a vehicle and/or vehicle component), robots (e.g., autonomous robots, stationary robots, among other robot types), conveyors, storage racks, pallets, machinery, operators, sensors, vehicles (e.g., automated guided vehicles), and/or other components of a manufacturing environment.

The reference CAD objects 112 may have various CAD graphic formats, such as a two-dimensional (2D) graphic type, a three-dimensional (3D) graphic type, an augmented reality graphic type, a virtual reality graphic type, or a combination thereof. In one form, the reference CAD object database 110 stores the reference CAD objects 112 in a neutral format that can be interpreted by any type of CAD modeling software executed by the client computing devices 200, such as CATIA V5, AutoStudio, NX, or other types of CAD modeling software. As an example, the reference CAD objects 112 are provided by Standard for the Exchange of Product Data (STEP) files, Initial Graphics Exchange Specification (IGES) files, among other neutral formats.

In one form, the CAD file database 120 comprises one or more master CAD files 122-1, . . . 122-n (collectively referred to hereinafter as “master CAD files 122”). Each of the master CAD files 122 includes master object information. As used herein, “master object information” refers to CAD objects of the master CAD files 122 that are utilized in component and/or workstation design and one or more properties associated with the CAD objects. As an example, the master object information defines the tools, fixtures, workpieces, robots, conveyors, storage racks, pallets, machinery, operators, sensors, vehicles, and/or other components of at least a portion of the manufacturing environment. Furthermore, the properties may define any physical, location-based, and/or material properties associated with the CAD objects, such as dimensions, size, volume, area, surface geometries, surface characteristics, a location within the manufacturing environment, among various other types of physical or material properties. It should be understood that the property of the CAD objects may include other types of physical, location-based, and material properties and are not limited to the examples described herein.

Additionally, each of the master CAD files 122 includes master identification information. As used herein, the “master identification information” refers to identifying indicia associated with the CAD objects defined by the master object information. In one form, each of the CAD objects is assigned to a unique identification text string that is interpretable by each of the client computing devices 200 regardless of the type and/or version of CAD modeling software executed by the client computing devices 200 (i.e., the master identification information is agnostic). As an example, a first tool of the master CAD file 122 has the unique identification string “SB43,” a second tool of the master CAD file 122 has the unique identification string “SB97,” a robot of the master CAD file 122 has the unique identification string “AX71,” and a workpiece of the master CAD file 122 has the unique identification string “BC23.” It should be understood that the master identification information of the CAD objects may include other types of text strings and/or identifying indicia and is not limited to the examples described herein.

The master CAD file update module 130 selectively updates the master CAD files 122 based on a command generated by one of the client computing devices 200. Additional details regarding the selective updating of the master CAD files 122 are provided below.

In one form, each of the client computing devices 200 includes a client database 210, an input module 220, a file creation module 230, a file modification module 240, and a local CAD file update module 250. The client database 210 comprises one or more local CAD files 212-1, . . . 212-n (collectively referred to hereinafter as “local CAD files 212”). Each of the local CAD files 212 includes local object information. As used herein, “local object information” refers to CAD objects of the local CAD files 212 that are utilized in component and/or workstation design and one or more properties associated with the CAD objects. As an example, the local object information defines the tools, fixtures, workpieces, robots, conveyors, storage racks, pallets, machinery, operators, sensors, vehicles, and/or other components of at least a portion of the manufacturing environment. Furthermore, the properties may define any physical, location-based, and/or material properties associated with the CAD objects, such as dimensions, size, volume, area, surface geometries, surface characteristics, a location within the manufacturing environment, among various other types of physical or material properties. It should be understood that the property of the CAD objects may include other types of physical, location-based, and material properties and are not limited to the examples described herein.

Additionally, each of the local CAD files 212 includes local identification information. As used herein, the “local identification information” refers to identifying indicia associated with the CAD objects defined by the local object information. In one form, the local identification information is agnostic among various CAD modeling software types and versions. In one form, each of the CAD objects is assigned to a unique identification text string that is interpretable by each of the client computing devices 200 regardless of the type and/or version of CAD modeling software executed by the client computing devices 200. As an example, a first tool of the local CAD file 212 has the unique identification string “SX54,” a robot of the local CAD file 212 has the unique identification string “ZF48,” and a workpiece of the local CAD file 212 has the unique identification string “VC41.” It should be understood that the local identification information of the CAD objects may include other types of text strings and/or identifying indicia and is not limited to the examples described herein.

In one form, the input module 220 includes an input device that is configured to receive inputs from an operator while executing CAD modeling software. As an example, the input device may be provided by a user interface (UI) element of a display device (e.g., a touchscreen display device, a desktop monitor, among other display devices), a joystick, a button, a keyboard, a mouse, an augmented reality input device, and/or a virtual reality input device. It should be understood that the input device may be provided by any device that is configured to receive inputs from an operator and is not limited to the examples described herein.

The input module 220 determines whether the input received by the input device from the operator satisfies a file creation condition or a file modification condition. As an example, the input satisfies the file creation condition in response to the input corresponding to the client computing device 200 generating a new/additional local CAD file 212 while executing the CAD modeling software. As another example, the input satisfies the file modification condition in response to the input corresponding to the client computing device 200 opening one of the local CAD files 212 or modifying local object information of one of the local CAD files 212 while executing the CAD modeling software. Modifying local object information includes, but is not limited to, adjusting one of the physical, location-based, and/or material properties of a local CAD object of a given local CAD file 212, deleting a local CAD object from the given local CAD file 212, and/or adding a new local CAD object to the given local CAD file 212.

In one form, the file creation module 230 is configured to instruct, in response to the input satisfying the file creation condition, the master CAD file update module 130 of the server computing device 100 to generate an additional master CAD file 212 based on the input and the plurality of reference CAD objects 112 of the reference CAD object database 110. As an example, when the operator of the client computing device 200-1 generates a new local CAD file 212 (as the input), the file creation module 230 instructs the master CAD file update module 130 to generate a new master CAD file 122 that corresponds to the new local CAD file 212. In addition to generating and storing the new master CAD file 122, the master CAD file update module 130 is configured to append the master identification information and the master object information to the new master CAD file 122, thereby enabling the server computing device 100 and the client computing device 200 to collectively update the new master CAD file 122 and the corresponding local CAD files 212, as described below in further detail.

In one form, the file modification module 240 is configured to instruct, in response to the input satisfying the file modification condition, the master CAD file update module 130 to selectively update one or more of the master CAD files 122. As an example, the file modification condition is satisfied when the input received by the client computing device 200-1 is associated with opening a local CAD file. Subsequently, the file modification module 240 instructs the master CAD file update module 130 to identify and select a target master CAD file from among the master CAD files 122 that corresponds to the given local CAD file of the client computing device 200-1. In one form, the master CAD file update module 130 selects the target master CAD file having master identification information that matches local identification information of the given local CAD file.

As another example, the file modification condition is satisfied when the input received by the client computing device 200-1 is associated with modifying local object information of one of the local CAD files 212. Similar to the above example, the file modification module 240 instructs the master CAD file update module 130 to identify and select a target master CAD file from among the master CAD files 122 that corresponds to the given local CAD file of the client computing device 200-1. Specifically, the master CAD file update module 130 selects the target master CAD file having master identification information that matches local identification information of the given local CAD file.

When the master CAD file update module 130 identifies and selects the target master CAD file from among the master CAD files 122, the master CAD file update module 130 determines whether the master object information matches the local object information of the given local CAD file and selectively updates the master CAD file accordingly. As an example, the master CAD file update module 130 determines whether the one or more properties associated with the CAD objects of the master CAD file (i.e., the master object information) matches the one or more properties associated with the CAD objects of the given local CAD file (i.e., the local object information). If the master object information and the local object information do not match (e.g., an operator of the client computing device 200-1 modified the given local CAD file offline or while connected to the distributed CAD system 10), the master CAD file update module 130 updates the master CAD file by adjusting the master object information to match the local object information. If the master object information and the local object information match, the master CAD file update module 130 refrains from updating the master CAD file.

In some forms, the master CAD file update module 130 may receive an instruction from a plurality of file modification modules 240 (e.g., the file modification modules 240 of the client computing devices 200-1, 200-2) to selectively update one or more of the master CAD files 122 within a threshold period of time (e.g., 1 second or less, 2 seconds or less, among other time periods). If multiple instructions to selectively update the one or more of the master CAD files 122 are received within the threshold period, the master CAD file update module 130 may update the one or more master CAD files based one or more control rules. As an example, if multiple instructions to selectively update the same master CAD file 122 are received within the threshold period, the master CAD file update module 130 may update the master CAD file 122 based on a predefined modification hierarchy associated with the client computing devices 200-1, 200-2. That is, the master CAD file update module 130 may disregard the input associated with the client computing device 200-2 when it has a lower modification hierarchy value or ranking than the client computing device 200-1.

In response to updating the target master CAD file, the master CAD file update module 130 is configured to instruct the local CAD file update modules 250 of at least a set of the additional client computing devices (e.g., the client computing devices 200-2, 200-3, 200-n in the above example) to identify and select one or more target local CAD files stored on the client databases 210 of the remaining client computing devices 200. In one form, the local CAD file update modules 250 identify and select the target local CAD files having local identification information that matches the master identification information of the target master CAD file.

When the local CAD file update modules 250 identify and select the target local CAD files of the client databases 210, the local CAD file update modules 250 determine whether the local object information matches the master object information of the given target master CAD file and selectively updates the target local CAD files accordingly. As an example, the local CAD file update modules 250 determine whether the one or more properties associated with the CAD objects of the target local CAD files (i.e., the local object information) match the one or more properties associated with the CAD objects of the target master CAD file (i.e., the master object information). If the master object information and the local object information do not match, the local CAD file update modules 250 update the target local CAD files by adjusting the local object information to match the local object information. If the master object information and the local object information match, the local CAD file update modules 250 refrain from updating the target local CAD files.

As another example, the file modification condition is satisfied when the input received by the client computing device 200-1 is associated with modifying local object information of one of the local CAD files 212. Similar to the above example, the file modification module 240 instructs the master CAD file update module 130 to identify and select a target master CAD file from among the master CAD files 122 that corresponds to the given local CAD file of the client computing device 200-1.

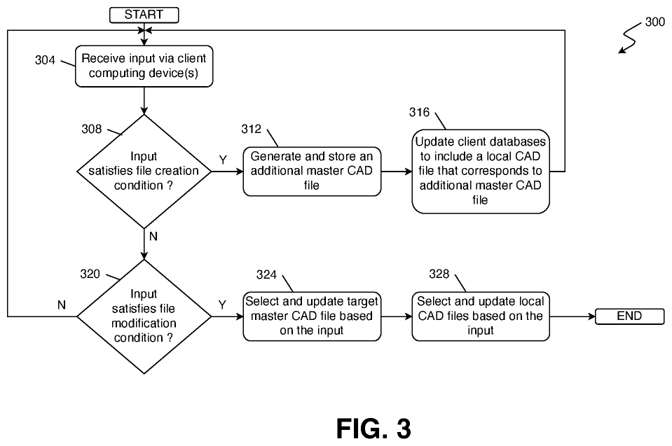

Referring to FIG. 3, a flowchart illustrating an example routine 300 for managing the distributed CAD system 10 is shown. At 304, the distributed CAD system 10 receives inputs via one of the client computing devices 200. At 308, the client computing device 200 determines whether the input satisfies a file creation condition. If the input satisfies the file creation condition, the routine 300 proceeds to 312. Otherwise, if the input does not satisfy the file creation condition, the routine 300 proceeds to 320. At 312, the server computing device 100 generates and stores an additional master CAD file among the one or more master CAD files 122 and, at 316, instructs the client computing devices 200 to generate and store a local CAD file that corresponds to the additional master CAD file. The routine 300 then proceeds to 304.

At 320, the client computing device 200 determines whether the input satisfies a file modification condition. If the input satisfies the file modification condition, the routine 300 proceeds to 324. Otherwise, if the input does not satisfy the file creation condition, the routine 300 proceeds to 304. At 324, the server computing device 100 selects and updates the target master CAD file among the one or more master CAD files 122 and, at 328, instructs the client computing devices 200 to select and update a corresponding target local CAD file based on the input.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A distributed computer-aided design (CAD) system comprising:
a server computing device comprising a reference CAD object database and a CAD file database, wherein the reference CAD object database comprises a plurality of reference CAD objects, wherein the CAD file database comprises one or more master CAD files, and wherein each of the one or more master CAD files comprises master object information and master identification information; and
a plurality of client computing devices communicably coupled to the server computing device, wherein each of the plurality of client computing devices comprises a client database, wherein each client database comprises one or more local CAD files and local object information associated with each of the one or more local CAD files, and wherein:
the server computing device is configured to determine whether an input received by a given client computing device from among the plurality of client computing devices satisfies one of a file creation condition and a file modification condition;
in response to the input satisfying the file creation condition, the server computing device is configured to generate an additional master CAD file from among the one or more master CAD files based on the input and the plurality of reference CAD objects;
in response to the input satisfying the file modification condition, the server computing device is configured to select a target master CAD file from among the one or more master CAD files based on the input, select one or more target local CAD files from among the one or more local CAD files stored on each client database of one or more additional client computing devices from among the plurality of client computing devices, and selectively update the target master CAD file; and
in response to the input satisfying the file modification condition, the one or more additional client computing devices are configured to selectively update the one or more target local CAD files.

2. The distributed CAD system of claim 1, wherein each reference CAD object from among the plurality of reference CAD objects is associated with one or more CAD graphic formats.

3. The distributed CAD system of claim 2, wherein the one or more CAD graphic formats includes a two-dimensional (2D) graphic type, a three-dimensional (3D) graphic type, an augmented reality graphic type, a virtual reality graphic type, or a combination thereof.

4. The distributed CAD system of claim 1, wherein the input satisfies the file creation condition in response to the input corresponding to the given client computing device generating an additional local CAD file from among the one or more local CAD files.

5. The distributed CAD system of claim 1, wherein the input satisfies the file modification condition in response to the input corresponding to the given client computing device opening a given local CAD file from among the one or more local CAD files.

6. The distributed CAD system of claim 5, wherein the server computing device is further configured to:
select the target master CAD file based on local identification information of the given local CAD file, wherein the master identification information of the target master CAD file matches the local identification information of the given local CAD file;
determine whether the master object information of the target master CAD file matches local object information of the given local CAD file; and
update the target master CAD file in response to the local object information of the given local CAD file not matching the master object information.

7. The distributed CAD system of claim 6, wherein:
the server computing device is further configured to select the one or more target local CAD files based on the master identification information and local identification information of the one or more target local CAD files, wherein the master identification information of the target master CAD file matches the local identification information of the one or more target local CAD files;
the server computing device is further configured to determine whether the master object information matches local object information of the one or more target local CAD files; and
the one or more additional client computing devices are further configured to update the one or more target local CAD files in response to the local object information of the one or more target local CAD files not matching the master object information.

8. The distributed CAD system of claim 1, wherein the input satisfies the file modification condition in response to the input corresponding to the given client computing device modifying local object information of a given local CAD file from among the one or more local CAD files.

9. The distributed CAD system of claim 8, wherein the server computing device is further configured to:
select the target master CAD file based on local identification information of the given local CAD file, wherein the master identification information of the target master CAD file matches the local identification information of the given local CAD file; and
update the master object information of the target master CAD file based on the local object information of the given local CAD file.

10. The distributed CAD system of claim 9, wherein:
the server computing device is further configured to select the one or more target local CAD files based on the master identification information and local identification information of the one or more target local CAD files, wherein the master identification information of the target master CAD file matches the local identification information of the one or more target local CAD files; and
the one or more additional client computing devices are further configured to update local object information of the one or more target local CAD files based on the master object information of the target master CAD file.

11. A method for managing a distributed computer-aided design (CAD) system comprising a server computing device communicably coupled to a plurality of client computing devices, the method comprising:
determining, by the server computing device, whether an input received by a given client computing device from among the plurality of client computing devices satisfies one of a file creation condition and a file modification condition, wherein:
the server computing device comprises a reference CAD object database and a CAD file database;
the reference CAD object database comprises a plurality of reference CAD objects;
the CAD file database comprises one or more master CAD files;
each of the one or more master CAD files comprises master object information and master identification information;
each of the plurality of client computing devices comprises a client database; and
each client database comprises one or more local CAD files and local object information associated with each of the one or more local CAD files;
generating, by the server computing device and in response to the input satisfying the file creation condition, an additional master CAD file from among the one or more master CAD files based on the input and the plurality of reference CAD objects; and
in response to the input satisfying the file modification condition:
selecting, by the server computing device, a target master CAD file from among the one or more master CAD files based on the input;
selecting, by the server computing device, one or more target local CAD files from among the one or more local CAD files stored on each client database of one or more additional client computing devices from among the plurality of client computing devices;
selectively updating, by the server computing device, the target master CAD file; and
selectively updating, by the one or more additional client computing devices, the one or more target local CAD files.

12. The method of claim 11, wherein each reference CAD object from among the plurality of reference CAD objects is associated with one or more CAD graphic formats.

13. The method of claim 12, wherein the one or more CAD graphic formats includes a two-dimensional (2D) graphic type, a three-dimensional (3D) graphic type, an augmented reality graphic type, a virtual reality graphic type, or a combination thereof.

14. The method of claim 11, wherein the input satisfies the file creation condition in response to the input corresponding to the given client computing device generating an additional local CAD file from among the one or more local CAD files.

15. The method of claim 11, wherein the input satisfies the file modification condition in response to the input corresponding to the given client computing device opening a given local CAD file from among the one or more local CAD files.

16. The method of claim 15, wherein selecting the target master CAD file is further based on local identification information of the given local CAD file, wherein the master identification information of the target master CAD file matches the local identification information of the given local CAD file, and wherein the method further comprises:
determining, by the server computing device, whether the master object information of the target master CAD file matches local object information of the given local CAD file; and
updating, by the server computing device, the target master CAD file in response to the local object information of the given local CAD file not matching the master object information.

17. The method of claim 16, wherein selecting the one or more target local CAD files is further based on the master identification information and local identification information of the one or more target local CAD files, wherein the master identification information of the target master CAD file matches the local identification information of the one or more target local CAD files, and wherein the method further comprises:
determining, by the server computing device, whether the master object information matches local object information of the one or more target local CAD files; and
updating, by the one or more additional client computing devices, the one or more target local CAD files in response to the local object information of the one or more target local CAD files not matching the master object information.

18. The method of claim 11, wherein the input satisfies the file modification condition in response to the input corresponding to the given client computing device modifying local object information of a given local CAD file from among the one or more local CAD files.

19. The method of claim 18, wherein selecting the target master CAD file is further based on local identification information of the given local CAD file, wherein the master identification information of the target master CAD file matches the local identification information of the given local CAD file, and wherein the method further comprises:
updating, by the server computing device, the master object information of the target master CAD file based on the local object information of the given local CAD file.

20. The method of claim 19, wherein selecting the one or more target local CAD files is further based on the master identification information and local identification information of the one or more target local CAD files, wherein the master identification information of the target master CAD file matches the local identification information of the one or more target local CAD files, and wherein the method further comprises:
updating, by the one or more additional client computing devices, local object information of the one or more target local CAD files based on the master object information of the target master CAD file.
